(19) United States
(12) Patent Application Publication
(10) Pub. No.: US 2026/0288094 A1
(43) Pub. Date: Sep. 24, 2026

(54) CONTROL PARAMETER ADJUSTMENT APPARATUS, CONTROL PARAMETER ADJUSTMENT METHOD, AND STORAGE MEDIUM

(71) Applicant: SCREEN Holdings Co., Ltd., Kyoto (JP)

(72) Inventors: Takashi IKEUCHI, Kyoto-shi (JP); Kazuma NAKAGAWA, Kyoto-shi (JP); Manri TERADA, Kyoto-shi (JP)

(21) Appl. No.: 19/557,035

(22) Filed: Mar. 4, 2026

(30) Foreign Application Priority Data
Mar. 18, 2025 (JP) 2025-043720

(51) Int. Cl. G05B 13/04; G05B 13/02

(52) U.S. Cl. CPC G05B 13/041; G05B 13/0265

(57) ABSTRACT

The control unit sets a connection relationship between nodes using an explanatory variable x, an intermediate variable f, and an objective variable y as nodes (connection relationship setting step). The control unit learns an input/output relationship of the intermediate variable f in a network based on the connection relationship set by the connection relationship setting processing using a data set of the explanatory variable x and the intermediate variable f (first learning processing). The control unit learns an input/output relationship of the objective variable z in the network using the data set of the explanatory variable x, the intermediate variable f, and the objective variable z (second learning processing). In the second learning processing, a prior distribution that induces sparsity is used as a prior distribution of weight parameters.

### RELATED APPLICATIONS

This application claims the benefit of Japanese Application No. 2025-043720 filed on Mar. 18, 2025, the disclosure of which is incorporated by reference herein.

### BACKGROUND OF THE INVENTION

### Field of the Invention

The subject matter disclosed herein relates to a control parameter adjustment apparatus, a control parameter adjustment method, and a computer program.

### Description of the Background Art

A substrate processing apparatus operates based on a control parameter set by a recipe or the like, and performs substrate processing. In this apparatus, it is necessary to appropriately adjust a set value of the control parameter in order for the processing result to be within a target value or allowable range. Normally, in the adjustment of the control parameter, the substrate processing is repeated while changing the set value, and the adjustment is performed by confirming the result. In this method, since many trials are required, the adjustment work takes time and labor.

In a case of efficiently optimizing the control parameter while suppressing cost, Bayesian optimization is an example of one effective method. In Bayesian optimization, the control parameter is used as an explanatory variable, the quality of substrate processing as an objective variable, and a learned model that outputs a predictive distribution of the relationship between the variables is learned, a search range of the control parameter, and an acquisition function are employed to select the control parameter value within the search range that maximizes the acquisition function.

In Bayesian optimization, there is a method incorporating gray box optimization that utilizes information obtained in an optimization process for the purpose of more efficiently performing the optimization. Specifically, it is conceivable to use detection data (physical quantity) detected by a sensor provided in the substrate processing apparatus as an intermediate variable.

For example, Japanese Patent Application Laid-Open No. 2024-046993 proposes a support apparatus utilizing machine learning in order to improve the quality of substrate processing. An object of this support apparatus is to reduce adjustment work caused by trial and error in the related art and to efficiently derive an optimum control parameter. Specifically, first, a first machine learning model is learned using the detection data of the physical quantity in the substrate processing and quality data of the processing result, and a prediction model of the processing result is constructed. Thereafter, a recommended value of the detection data is acquired so as to get close to the target quality using the method in Bayesian optimization. Next, a relationship between the set value of the control parameter and the detection data is learned by a second machine learning model, and a recommended value of the control parameter is calculated based on the acquired recommended value of the detection data.

### SUMMARY OF THE INVENTION

### Technical Problem

However, in the method of Japanese Patent Application Laid-Open No. 2024-046993, although the relationship between the intermediate variable and the objective variable and the relationship between the explanatory variable and the intermediate variable are learned, the direct relationship between the explanatory variable and the objective variable is not learned. Therefore, there is a possibility that the derivation accuracy of the recommended value of the optimal control parameter is limited.

Meanwhile, the causal relationship between the explanatory variable (control parameter) and the objective variable (processing result) is not always clear in many cases. Even in the actual substrate processing, a data generation process of the processing result (objective variable) is hardly clear. That is, the causal relationship between the set value of the control parameter (explanatory variable) and the measurement data (intermediate variable) is often clear, but the causal relationship between the set value of the control parameter (explanatory variable) and the result of the substrate processing (objective variable) is often unknown. Therefore, it is difficult to appropriately set a network that correctly indicates the data generation process of the objective variable.

If the network that represents the data generation process is set inappropriately, the prediction accuracy of the objective variable and the optimization accuracy may decrease. In particular, an increase in the dimensionality of the input to the objective variable causes the curse of dimensionality, and thus not only convergence of learning is delayed but also a risk of overfitting may increase. As a result, the fitting performance of the model may be deteriorated, or the number of times of searching for the optimum control parameter may be increased.

An object of the present invention is to provide a technique that improves the quality of substrate processing even where the causal relationship between a control parameter and a the processing result is not sufficiently clear.

### Solution to Problem

In order to solve the above problem, a first aspect is a control parameter adjustment apparatus that adjusts a set value of a control parameter of a substrate processing apparatus that operates based on the control parameter to process a substrate, including an arithmetic processing unit that calculates a recommended value of the control parameter, wherein the arithmetic processing unit can execute: connection relationship setting processing of setting a connection relationship between nodes by using the control parameter as an explanatory variable, using measurement data related to a physical quantity measured by the substrate processing apparatus as an intermediate variable, using quality data related to a quality of substrate processing by the substrate processing apparatus as an objective variable, and using the explanatory variable, the intermediate variable, and the objective variable as nodes; first learning processing of learning an input/output relationship of the intermediate variable in a network based on the connection relationship set by the connection relationship setting processing using a data set of the explanatory variable and the intermediate variable; second learning processing of learning an input/output relationship of the objective variable in the network using a data set of the explanatory variable, the intermediate variable, and the objective variable; and search processing of executing Bayesian optimization using a prediction model obtained by the first learning processing and the second learning processing, a search range, and an acquisition function, and searching for a recommended value of the control parameter that brings the quality close to a target quality, and the arithmetic processing unit uses a prior distribution that induces sparsity as a prior distribution of weight parameters in the second learning processing.

According to the first aspect, by using the prior distribution that induces sparsity, the value of an important input for the objective variable is maintained at a large value and an unimportant input is reduced. With this characteristic, the important input of the objective variable can be appropriately learned. Therefore, even in a case where the explanatory variable and the intermediate variable having low importance are connected to the objective variable in the network, it is possible to avoid a decrease in prediction accuracy of the network. Accordingly, it is possible to avoid a decrease in the optimization accuracy of the control parameter, and thus, it is possible to improve the quality of the substrate processing.

A second aspect is the control parameter adjustment apparatus according to the first aspect, wherein, in the connection relationship setting processing, the arithmetic processing unit sets all the selectable explanatory variables, all the selectable intermediate variables, or both of them as parent nodes of the objective variable.

A third aspect is the control parameter adjustment apparatus according to the first aspect, wherein the arithmetic processing unit uses a half-Cauchy distribution as the prior distribution in the second learning processing.

A fourth aspect is the control parameter adjustment apparatus according to the first aspect, further including: an input unit that receives an input; and a display, wherein in the connection relationship setting processing, the arithmetic processing unit performs processing of displaying, on the display, a GUI for receiving an input designating a connection relationship between a node of the explanatory variable and a node of the intermediate variable, an input designating a connection relationship between nodes of the intermediate variable, or both, and setting a connection of each node based on the input received via the input unit.

A fifth aspect is the control parameter adjustment apparatus according to the fourth aspect, wherein, in the connection relationship setting processing, the arithmetic processing unit performs processing of displaying, on the display, a GUI for receiving an input designating a connection relationship between a node of the explanatory variable and a node of the objective variable, an input designating a connection relationship between a node of the intermediate variable and a node of the objective variable, or both inputs, and setting a connection of each node based on the input received via the input unit.

A sixth aspect is the control parameter adjustment apparatus according to the fifth aspect, wherein the arithmetic processing unit displays, as a parent node of the objective variable, a GUI on the display, the GUI including an option for selecting variables one by one from the selectable explanatory variables or the selectable intermediate variables, and an option for selecting all the selectable explanatory variables or all the selectable intermediate variables at once.

A seventh aspect is a control parameter adjustment method for adjusting a set value of a control parameter of a substrate processing apparatus that operates based on the control parameter to process a substrate, including: connection relationship setting processing of setting a connection relationship between nodes by using the control parameter as an explanatory variable, using measurement data related to a physical quantity measured by the substrate processing apparatus as an intermediate variable, using quality data related to a quality of substrate processing by the substrate processing apparatus as an objective variable, and using the explanatory variable, the intermediate variable, and the objective variable as nodes; first learning processing of learning an input/output relationship of the intermediate variable in a network based on the connection relationship set by the connection relationship setting processing using a data set of the explanatory variable and the intermediate variable; second learning processing of learning an input/output relationship of the objective variable in the network using a data set of the explanatory variable, the intermediate variable, and the objective variable; and search processing of executing Bayesian optimization using a prediction model obtained by the first learning processing and the second learning processing, a search range, and an acquisition function, and searching for a recommended value of the control parameter that brings the quality close to a target quality.

An eighth aspect is a computer program executable by a computer, the computer program causing the computer to execute each piece of processing of the control parameter adjustment method according to the seventh aspect.

These and other objects, features, aspects and advantages of the present invention will become more apparent from the following detailed description of the present invention when taken in conjunction with the accompanying drawings.

### BRIEF DESCRIPTION OF THE DRAWING

FIG. 1 is a diagram illustrating an outline of a control parameter adjustment method according to the present preferred embodiment;

FIG. 2 is a diagram illustrating an example of a quality inspection step indicated in FIG. 1;

FIG. 3 is a diagram illustrating a substrate processing system and an inspection apparatus;

FIG. 4 is a top view schematically illustrating a configuration of a substrate processing apparatus included in the substrate processing system;

FIG. 5 is a cross-sectional view schematically illustrating a configuration of a substrate processing unit illustrated in FIG. 4;

FIG. 6 is a block diagram illustrating a configuration of a control apparatus according to the present preferred embodiment;

FIG. 7 is a diagram illustrating a data set including a set value of a control parameter, measurement data, and quality data;

FIG. 8 is a flowchart illustrating the control parameter adjustment method according to the preferred embodiment;

FIG. 9 is a diagram illustrating a post-preprocessing data set including set values of the control parameter, post-preprocessing measurement data, and quality data;

FIG. 10 is a detailed flowchart of a learning step illustrated in FIG. 8;

FIG. 11 is a diagram conceptually illustrating a network;

FIG. 12A is a diagram illustrating a GUI for designating a connection relationship of the network;

FIG. 12B is a diagram illustrating a GUI for designating a connection relationship of the network;

FIG. 12C is a diagram illustrating a GUI for designating a connection relationship of the network; and

FIG. 13 is a diagram illustrating a modification of a GUI for designating a connection relationship of the network.

### DESCRIPTION OF THE PREFERRED EMBODIMENTS

Hereinafter, a preferred embodiment of the present invention will be described with reference to the accompanying drawings. Note that, in the drawings, dimensions and the number of units may be exaggerated or simplified in order to facilitate understanding.

In the present preferred embodiment, a “substrate” refers to various types of substrates, and specifically, is a semiconductor wafer, a glass substrate for a photomask, a glass substrate for a liquid crystal display, a glass substrate for a plasma display, a substrate for a field emission display (FED), a substrate for an optical disk, a substrate for a magnetic disk, a substrate for a magneto-optical disk, or the like. Hereinafter, a control parameter adjustment method, a control parameter adjustment apparatus, and a computer program used for the processing of a disk-shaped semiconductor wafer will be mainly described, but a control parameter adjustment method, a control parameter adjustment apparatus, and a computer program can be similarly applied to the processing of various types of substrates exemplified above. In addition, they can be applied to a substrate having various shapes.

### 1. Preferred Embodiment

An object of the control parameter adjustment method of the present preferred embodiment is to adjust a set value X of a control parameter of a substrate processing apparatus 100. In the control parameter adjustment method, an appropriate recommended value RX (recommended condition) of the control parameter is acquired using the machine learning model, and the set value X of the control parameter is adjusted based on the recommended value RX. Here, the set value X of the control parameter refers to a value of each of various control parameters set in the substrate processing apparatus 100. Note that the set value X of the control parameter may be not only a control parameter defined in a recipe but also a control parameter not defined in the recipe.

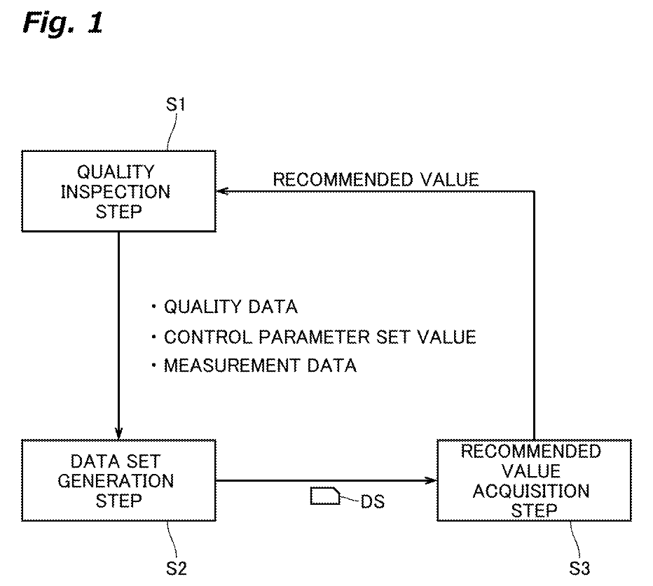

FIG. 1 is a diagram illustrating an outline of the control parameter adjustment method according to the present preferred embodiment. The control parameter adjustment method includes processing of a quality inspection step S1, a data set generation step S2, and a recommended value acquisition step S3. The processing from the quality inspection step S1 to the recommended value acquisition step S3 is repeatedly executed until the quality of the substrate processing of the substrate processing apparatus 100 reaches the target value or the allowable value.

In the quality inspection step S1, quality inspection (experiment) is performed. The index of the quality is, for example, the number of particles attached to a substrate W by the substrate processing, the collapse ratio, or the etching amount. In the quality inspection step S1, the substrate processing apparatus 100 is caused to process the unprocessed substrate W based on the value of the control parameter, the processed substrate W is inspected, and quality data Y regarding the quality of the substrate processing by the substrate processing apparatus 100 is acquired. Note that, in the following description, the unprocessed substrate W may be referred to as an “unprocessed substrate Wa”, and the processed substrate W may be referred to as a “processed substrate Wb”.

In the data set generation step S2, an inspection apparatus 300 generates data set DS1 based on the quality data Y, the set value X of the control parameter, and measurement data Z1. The measurement data Z1 indicates a physical quantity measured by a sensor or the like provided in the substrate processing apparatus 100.

In the recommended value acquisition step S3, a control apparatus 200 learns the data set using the machine learning model. Then, the recommended value RX of the control parameter is acquired by Bayesian optimization using the learned machine learning model (prediction model PM). Then, the quality inspection step S1 is performed again after the set value X of the control parameter is adjusted to the recommended value RX. In a case where the result of the quality inspection (quality data Y) reaches the allowable value, the recommended value RX at that time is the optimized set value X of the control parameter. In a case where the result of the quality inspection does not reach the allowable value, the data set generation step S2 is executed again.

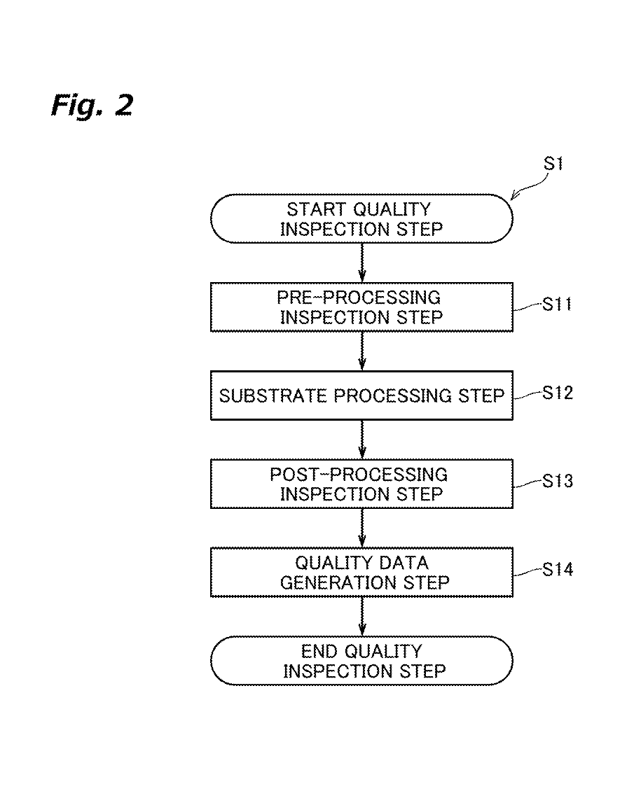

FIG. 2 is a diagram illustrating an example of the quality inspection step S1 illustrated in FIG. 1. Here, the description will be given assuming that the quality inspection step S1 is an inspection for measuring the number of particles attached to the substrate W by the substrate processing. The quality inspection step S1 includes a pre-processing inspection step S11, a substrate processing step S12, a post-processing inspection step S13, and a quality data generation step S14.

The pre-processing inspection step S11 is a step of inspecting the unprocessed substrate Wa. In a case where the quality inspection step S1 relates to the inspection of the number of particles, the distribution of particles attached to the substrate Wa is detected in the pre-processing inspection step S11. More specifically, coordinates of each particle attached to the unprocessed substrate Wa are acquired. The origin of the coordinates is the center of the substrate W. In the following description, particles attached to the unprocessed substrate Wa may be referred to as “pre-processing particles”.

In the substrate processing step S12 after the pre-processing inspection step S11, the substrate processing apparatus 100 processes the unprocessed substrate Wa. In a case where the quality inspection step S1 relates to the inspection of the number of particles, the substrate Wa is cleaned in the substrate processing step S12.

In the post-processing inspection step S13 after the substrate processing step S12, the processed substrate Wb is inspected. In the post-processing inspection step S13, the same inspection as the pre-processing inspection step S11 is performed. In a case where the quality inspection step S1 relates to the inspection of the number of particles, the distribution of particles attached to the substrate Wb is detected in the post-processing inspection step S13. More specifically, coordinates of each particle attached to the processed substrate Wb are acquired. In the following description, particles attached to the processed substrate Wb may be referred to as “post-processing particles”.

In the quality data generation step S14 after the post-processing inspection step S13, the quality data Y is generated. In a case where the quality inspection step S1 relates to the inspection of the particles, the number of particles attached to the substrate W by the substrate processing is calculated based on the distribution of the pre-processing particles and the distribution of the post-processing particles in the quality data generation step S14. Specifically, the following counting processing is executed. That is, it is determined whether or not any of the coordinates of the pre-processing particles is included in a circle having a radius Th centered on the coordinates of the post-processing particles to be inspected. Then, in a case where none of the coordinates of the pre-processing particles is included in the circle to be inspected, the post-processing particles to be inspected are regarded as the particles attached to the substrate W by the substrate processing and are counted. By executing this counting processing on all the post-processing particles, the quality data Y indicating the number of particles attached to the substrate W by the substrate processing is generated. When the quality data Y is generated, the quality inspection step S1 ends.

Note that the quality inspection step S1 is not limited to the inspection of the particle amount. For example, the quality inspection step S1 may be an inspection of the etching amount. In this case, the film thickness of the substrate Wa is measured in the pre-processing inspection step S11, etching is performed in the substrate processing step S12, and the film thickness of the substrate Wb is measured in the post-processing inspection step S13. Then, in the quality data generation step S14, the quality data Y indicating a difference between the film thickness of the unprocessed substrate Wa and the film thickness of the processed substrate Wb is generated.

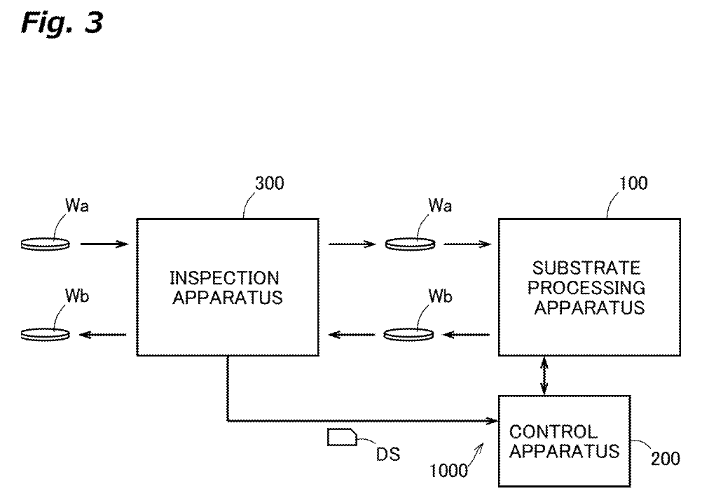

FIG. 3 is a diagram illustrating a substrate processing system 1000 and the inspection apparatus 300. The substrate processing system 1000 includes the substrate processing apparatus 100 and the control apparatus 200. The substrate processing apparatus 100 operates based on the set control parameter and performs processing on the unprocessed substrate Wa. The control apparatus 200 controls the operation of the substrate processing apparatus 100 based on the control parameter. The inspection apparatus 300 detects the distribution of particles attached to the substrate W. The inspection apparatus 300 acquires the coordinates of each particle attached to the substrate W to specify the distribution.

The inspection apparatus 300 generates the quality data Y. The inspection apparatus 300 compares the distribution of particles attached to the processed substrate Wb (post-processing particles) with the distribution of particles attached to the unprocessed substrate Wa (pre-processing particles), and calculates the number of particles newly attached by the substrate processing. Further, the inspection apparatus 300 executes predetermined counting processing for each post-processing particle and obtains the number of attached particles by the substrate processing. The inspection apparatus 300 generates quality data Y indicating the calculated number of attached particles. Note that the inspection apparatus 300 stores the radius Th in a storage unit.

The generated quality data Y is input to the control apparatus 200. The control apparatus 200 is an example of an apparatus that adjusts the control parameter of the substrate processing. There is a case where the quality data Y is transmitted from the inspection apparatus 300 to the control apparatus 200 via a cable, or is transmitted using wireless communication. In addition, a configuration in which the quality data Y is input to the control apparatus 200 via a removable medium is also possible. The removable medium may include a memory card such as an SD card, a storage medium such as a universal serial bus (USB) memory, and an optical disc such as a digital versatile disc (DVD).

Note that the control apparatus 200 may generate the quality data Y. In this case, the distribution of particles attached to the unprocessed substrate Wa (coordinates of each pre-processing particle) and the distribution of particles attached to the processed substrate Wb (coordinates of each post-processing particle) are input from the inspection apparatus 300 to the control apparatus 200.

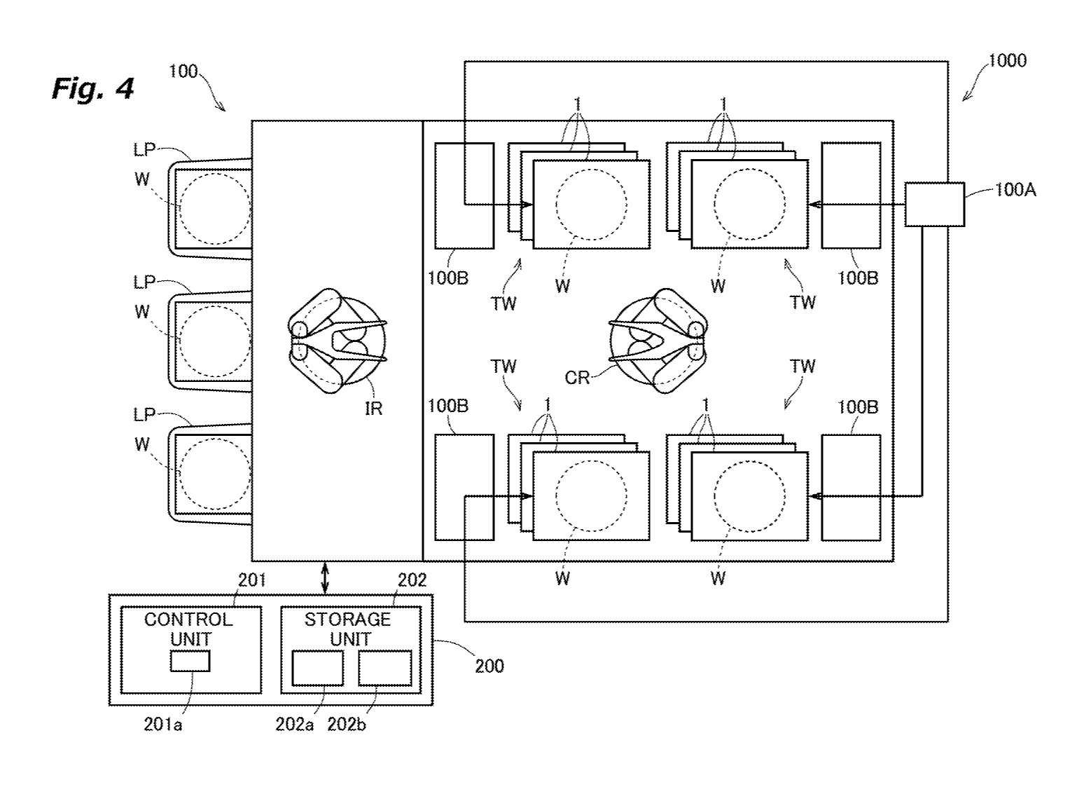

FIG. 4 is a top view schematically illustrating a configuration of the substrate processing apparatus 100 included in the substrate processing system 1000. The substrate processing apparatus 100 processes the substrate W using the processing solution. The substrate processing apparatus 100 according to the present preferred embodiment is a single wafer type apparatus that processes the substrates W one by one.

As illustrated in FIG. 4, the substrate processing apparatus 100 includes a plurality of substrate processing units 1, a fluid cabinet 100A, a plurality of fluid boxes 100B, a plurality of load ports LP, an indexer robot IR, and a center robot CR.

Each of the load ports LP accommodates a plurality of substrates W in a stacked state. The indexer robot IR plays a role of conveying the substrate W between the load port LP and the center robot CR. The center robot CR conveys the substrate W between the indexer robot IR and the substrate processing unit 1. A placing table (path) for temporarily placing the substrate W may be disposed between the indexer robot IR and the center robot CR. In this case, a system in which the indexer robot IR and the center robot CR indirectly transfer the substrate W via the placing table can be adopted.

The plurality of substrate processing units 1 form a plurality of towers TW. In the example illustrated in FIG. 4, the substrate processing apparatus 100 includes four towers TW. The plurality of towers TW is disposed around the center robot CR in plan view. Each of the towers TW includes the plurality of substrate processing units 1 stacked in the vertical direction. In the example of FIG. 4, three substrate processing units 1 are stacked in each tower TW.

The fluid cabinet 100A stores the processing solution used for the substrate processing. The plurality of fluid boxes 100B correspond to respective ones of different towers TW. The fluid cabinet 100A supplies the stored processing solution to each of the fluid boxes 100B. Each fluid box 100B supplies the processing solution to all the substrate processing units 1 in the corresponding tower TW.

Each of the substrate processing units 1 supplies the processing solution to the substrate W to process the substrate W. The processing solution may include a chemical solution and a rinse solution. The chemical solution is, for example, dilute hydrofluoric acid (DHF), hydrofluoric acid (HF), hydrofluoric nitric acid (mixed solution of hydrofluoric acid and nitric acid (HNO₃)), buffered hydrofluoric acid (BHF), ammonium fluoride, HFEG (mixed solution of hydrofluoric acid and ethylene glycol), phosphoric acid (H₃PO₄), sulfuric acid, acetic acid, nitric acid, hydrochloric acid, ammonia water, hydrogen peroxide water, organic acid (for example, citric acid and oxalic acid), organic alkali (for example, tetramethylammonium hydroxide:TMAH), sulfuric acid hydrogen peroxide water mixed solution (SPM), ammonia hydrogen peroxide water mixed solution (SC1), hydrochloric acid hydrogen peroxide water mixed solution (SC2), isopropyl alcohol (IPA), a surfactant, or a corrosion inhibitor. The rinse solution is, for example, pure water (deionized water or the like), carbonated water, electrolyzed ion water, hydrogen water, ozone water, or hydrochloric acid water having a dilution concentration (for example, about 10 PPM to 100 PPM).

The control apparatus 200 controls each unit of the substrate processing apparatus 100. For example, the control apparatus 200 controls the substrate processing units 1, the load port LP, the indexer robot IR, and the center robot CR. The control apparatus 200 includes a control unit 201 and a storage unit 202.

The control unit 201 includes a processor 201a. For example, the control unit 201 includes a central processing unit (CPU) or a micro processing unit (MPU). The control unit 201 may include a general-purpose computing unit, a dedicated computing unit, a graphics processing unit (GPU), a neural network processing unit (NPU), or a quantum computer. The dedicated computing unit includes, for example, an application specific integrated circuit (ASIC).

The control unit 201 controls each unit of the substrate processing apparatus 100 based on the data stored in the storage unit 202. The control unit 201 executes the data set generation step S2 and the recommended value acquisition step S3 illustrated in FIG. 1 based on the data stored in the storage unit 202. The control unit 201 is an example of an “arithmetic processing unit”.

The storage unit 202 includes a main storage apparatus 202a. The main storage apparatus 202a is, for example, a semiconductor memory. The storage unit 202 may include an auxiliary storage apparatus 202b. The auxiliary storage apparatus 202b is, for example, a semiconductor memory or a hard disk drive. The storage unit 202 may include a removable medium.

The auxiliary storage apparatus 202b stores data for controlling the operation of each unit of the substrate processing apparatus 100. In addition, the auxiliary storage apparatus 202b stores data for performing the data set generation step S2 and the recommended value acquisition step S3 illustrated in FIG. 1.

The auxiliary storage apparatus 202b stores a computer program. The computer program includes a control program for controlling the operation of the substrate processing apparatus 100. In addition, the computer program includes an adjustment program PR. The adjustment program PR includes a computer program for performing the data set generation step S2 and the recommended value acquisition step S3.

The auxiliary storage apparatus 202b stores recipe data. The recipe data indicates a recipe that defines processing contents, processing conditions, and processing procedures of the substrate W. In the recipe, various control parameters are defined as the processing conditions. In addition, the data includes various control parameters not defined in the recipe. Hereinafter, the set value of the control parameter defined in the recipe may be referred to as a “recipe set value”. In addition, the set value of the control parameter not defined in the recipe may be referred to as “non-recipe set value”.

The recipe set value includes a set value of a flow rate of various processing solutions, a set value of a substrate rotation speed, a set value of various pressures, various setting times, and the like. The non-recipe set value includes a set value of the temperature of the specific processing solution, and the like.

The processor 201a realizes the data set generation step S2 and the recommended value acquisition step S3 by reading the adjustment program PR stored in the auxiliary storage apparatus 202b into the main storage apparatus 202a and executing the adjustment program PR.

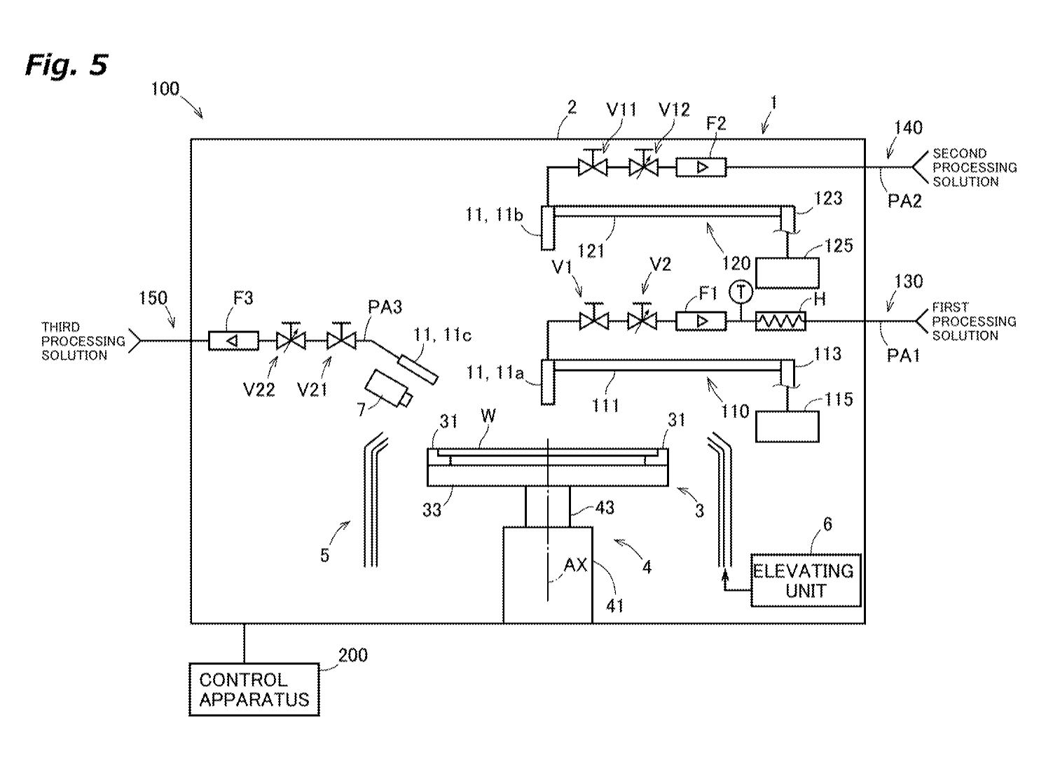

FIG. 5 is a cross-sectional view schematically illustrating a configuration of the substrate processing unit 1 illustrated in FIG. 4. The substrate processing unit 1 includes a chamber 2, a spin chuck 3, a spin motor 4, a guard unit 5, an elevating unit 6, a nozzle 11, a first nozzle moving unit 110, and a second nozzle moving unit 120. The substrate processing apparatus 100 includes a first supply unit 130, a second supply unit 140, and a third supply unit 150.

The chamber 2 accommodates the spin chuck 3, the spin motor 4, the guard unit 5, the elevating unit 6, a camera 7, the nozzle 11, the first nozzle moving unit 110, and the second nozzle moving unit 120. In the chamber 2, the substrates W are accommodated one by one.

The spin chuck 3 is a substrate holding unit that horizontally holds the substrate W. The spin chuck 3 includes a plurality of chuck members 31 and a spin base 33. The plurality of chuck members 31 is provided on the spin base 33 along the peripheral edge of the substrate W. The plurality of chuck members 31 holds the substrate W in a horizontal posture. The spin base 33 has a substantially disk shape and supports the plurality of chuck members 31 in a horizontal posture. The spin chuck 3 is controlled by the control apparatus 200.

The spin motor 4 integrally rotates the substrate W and the spin chuck 3 about a rotation axis AX. The rotation axis AX extends in a substantially vertical direction. The rotation axis AX is an example of a central axis, and the spin motor 4 is an example of a substrate rotation unit. The spin motor 4 is connected to the spin base 33 around the rotation axis AX and rotates the spin base 33. Therefore, the spin base 33 rotates about the rotation axis AX. As a result, the substrate W held by the plurality of chuck members 31 provided on the spin base 33 rotates about the rotation axis AX.

The spin motor 4 includes a motor body 41 and a shaft 43. The shaft 43 is coupled to the spin base 33. The motor body 41 rotates the shaft 43. As a result, the spin base 33 rotates. The motor body 41 is controlled by the control apparatus 200.

The nozzle 11 supplies the processing solution to the substrate W. In the present preferred embodiment, the nozzle 11 supplies a first processing solution, a second processing solution, and a third processing solution to the substrate W. More specifically, the nozzle 11 includes a first nozzle 11a, a second nozzle 11b, and a third nozzle 11c. The first nozzle 11a supplies the first processing solution to the substrate W. The first nozzle 11a discharges the first processing solution toward the rotating substrate W.

The first processing solution is a chemical solution. The first supply unit 130 supplies the first processing solution to the first nozzle 11a. The first supply unit 130 includes a first pipe PA1, a first on-off valve V1, a first control valve V2, a first flow rate sensor F1, a temperature sensor T, and a heating member H.

The first pipe PA1 causes the first processing solution to flow to the first nozzle 11a. Note that a part of the first pipe PA1 is accommodated in the chamber 2. The first on-off valve V1 is disposed in the first pipe PA1. The first on-off valve V1 switches between supply and stop of the first processing solution to the first nozzle 11a. An actuator of the first on-off valve V1 is, for example, a pneumatic actuator or an electric actuator. The first on-off valve V1 is controlled by the control apparatus 200.

The first control valve V2 controls the flow rate of the first processing solution flowing through the first pipe PA1. The first control valve V2 can adjust the opening degree of the first pipe PA1. An actuator of the first control valve V2 is, for example, an electric actuator. The first control valve V2 is controlled by the control apparatus 200.

The first flow rate sensor F1 detects the flow rate of the first processing solution flowing through the first pipe PA1. The flow rate of the first processing solution is an example of a “physical quantity”. The set value X of the control parameter includes a set value of the flow rate of the first processing solution. The set value of the flow rate of the first processing solution is an example of the recipe set value. A detection result SE of the first flow rate sensor F1 is an example of the measurement data Z1 and is input to the control apparatus 200.

The heating member H heats the first processing solution flowing through the first pipe PA1. The heating member H is controlled by the control apparatus 200. The temperature sensor T detects the temperature of the first processing solution flowing through the first pipe PA1. The temperature of the first processing solution is an example of a “physical quantity”. The set value X of the control parameter includes a set value of the temperature of the first processing solution. The set value of the temperature of the first processing solution is an example of the non-recipe set value. A detection result SE of the temperature sensor T is an example of the measurement data Z1 and is input to the control apparatus 200.

The first nozzle moving unit 110 moves the first nozzle 11a in the substantially vertical direction and the substantially horizontal direction. Specifically, the first nozzle moving unit 110 includes a first arm 111, a first rotary shaft 113, and a first nozzle moving mechanism 115.

The first arm 111 extends along the substantially horizontal direction. The first nozzle 11a is disposed at a distal end of the first arm 111. The first arm 111 is coupled to the first rotary shaft 113. The first rotary shaft 113 extends along the substantially vertical direction.

The first nozzle moving mechanism 115 rotates the first rotary shaft 113 about a rotary axis along the substantially vertical direction to rotate the first arm 111 along a substantially horizontal plane. As a result, the first nozzle 11a moves along the substantially horizontal plane. The first nozzle moving mechanism 115 raises and lowers the first arm 111 by raising and lowering the first rotary shaft 113 along the substantially vertical direction. As a result, the first nozzle 11a moves along the substantially vertical direction. The first nozzle moving mechanism 115 may include, for example, a ball screw mechanism and an electric motor that applies a driving force to the ball screw mechanism. The first nozzle moving mechanism 115 is controlled by the control apparatus 200.

The second nozzle 11b supplies the second processing solution to the substrate W. Specifically, the second nozzle 11b discharges the second processing solution toward the rotating substrate W. The second processing solution is a chemical solution.

The second supply unit 140 supplies the second processing solution to the second nozzle 11b. Specifically, the second supply unit 140 includes a second pipe PA2, a second on-off valve V11, a second control valve V12, and a second flow rate sensor F2.

The second supply unit 140 supplies the second processing solution to the second nozzle 11b. Specifically, the second supply unit 140 includes a second pipe PA2, a second on-off valve V11, a second control valve V12, and a second flow rate sensor F2.

The second pipe PA2 causes the second processing solution to flow to the second nozzle 11b. The chamber 2 accommodates a part of the second pipe PA2. The second on-off valve V11 is disposed in the second pipe PA2. The second on-off valve V11 switches between supply and stop of the second processing solution to the second nozzle 11b. An actuator of the second on-off valve V11 is, for example, a pneumatic actuator or an electric actuator. The second on-off valve V11 is controlled by the control apparatus 200.

The second control valve V12 controls the flow rate of the second processing solution flowing through the second pipe PA2. The second control valve V12 can adjust the opening degree of the second pipe PA2. An actuator of the second control valve V12 is, for example, an electric actuator. The second control valve V12 is controlled by the control apparatus 200.

The second flow rate sensor F2 detects the flow rate of the second processing solution flowing through the second pipe PA2. The flow rate of the second processing solution is an example of a “physical quantity”. The set value X of the control parameter includes a set value of the flow rate of the second processing solution. The set value of the flow rate of the second processing solution is an example of the recipe set value. A detection result SE of the second flow rate sensor F2 is an example of the measurement data Z1 and is input to the control apparatus 200.

The second nozzle moving unit 120 moves the second nozzle 11b in the substantially vertical direction and the substantially horizontal direction. Specifically, the second nozzle moving unit 120 includes a second arm 121, a second rotary shaft 123, and a second nozzle moving mechanism 125. The second nozzle moving mechanism 125 is controlled by the control apparatus 200. Since the configuration of the second nozzle moving unit 120 is substantially similar to that of the first nozzle moving unit 110, the description thereof will be omitted.

The third nozzle 11c supplies the third processing solution to the substrate W. The third nozzle 11c discharges the third processing solution toward the rotating substrate W. The third processing solution is a rinse liquid. The third nozzle 11c is a fixed nozzle.

The third supply unit 150 supplies the third processing solution to the third nozzle 11c. Specifically, the third supply unit 150 includes a third pipe PA3, a third on-off valve V21, a third control valve V22, and a third flow rate sensor F3.

The third pipe PA3 causes the third processing solution to flow to the third nozzle 11c. The chamber 2 accommodates a part of the third pipe PA3. The third on-off valve V21 is disposed in the third pipe PA3. The third on-off valve V21 switches between supply and stop of the third processing solution to the third nozzle 11c. An actuator of the third on-off valve V21 is, for example, a pneumatic actuator or an electric actuator. The third on-off valve V21 is controlled by the control apparatus 200.

The third control valve V22 controls the flow rate of the third processing solution flowing through the third pipe PA3. The third control valve V22 can adjust the opening degree of the third pipe PA3. An actuator of the third control valve V22 is, for example, an electric actuator. The third control valve V22 is controlled by the control apparatus 200.

The third flow rate sensor F3 detects the flow rate of the third processing solution flowing through the third pipe PA3. The flow rate of the third processing solution is an example of a “physical quantity”. The set value X of the control parameter includes a set value of the flow rate of the third processing solution. The set value of the flow rate of the third processing solution is an example of the recipe set value. A detection result SE of the third flow rate sensor F3 is input to the control apparatus 200 as the measurement data Z1.

The guard unit 5 is disposed outside the spin chuck 3 and the spin motor 4. The guard unit 5 has a substantially tubular shape. In other words, the guard unit 5 surrounds the spin chuck 3 and the spin motor 4. The guard unit 5 receives the processing solutions (first processing solution to third processing solution) scattered from the rotating substrate W. In the example illustrated in FIG. 5, the guard unit 5 includes three guards.

The elevating unit 6 individually raises and lowers the three guards. The elevating unit 6 is controlled by the control apparatus 200. Specifically, the elevating unit 6 raises and lowers the guard unit 5 (here, three guards) between a liquid receiving position and a retracting position. The liquid receiving position is a position above the retracting position.

When the substrate W is carried into the inside of the chamber 2 by the center robot CR (FIG. 4), the guard unit 5 is disposed at the retracting position. In addition, when the substrate W is carried out from the inside of the chamber 2 by the center robot CR, the guard unit 5 is disposed at the retracting position. Each guard is disposed at the liquid receiving position when receiving the processing solution.

The chamber 2 accommodates the camera 7. The camera 7 photographs, for example, an upper surface of the substrate W held by the spin base 33. The camera 7 includes an optical system, an imaging sensor, a signal processing circuit, and a control system (microcomputer). The imaging sensor is a semiconductor device such as a charge-coupled device (CCD) or a complementary metal oxide semiconductor (CMOS). Image data acquired by the imaging sensor is data representing a physical quantity such as brightness of an imaging target. The camera 7 inputs the acquired image data to the control apparatus 200 as the measurement data Z1.

Note that, although not illustrated, some airflow sensors that measure airflow may be provided at specific positions in the chamber 2. The detection results of these airflow sensors may be input to the control apparatus 200 as the measurement data Z1.

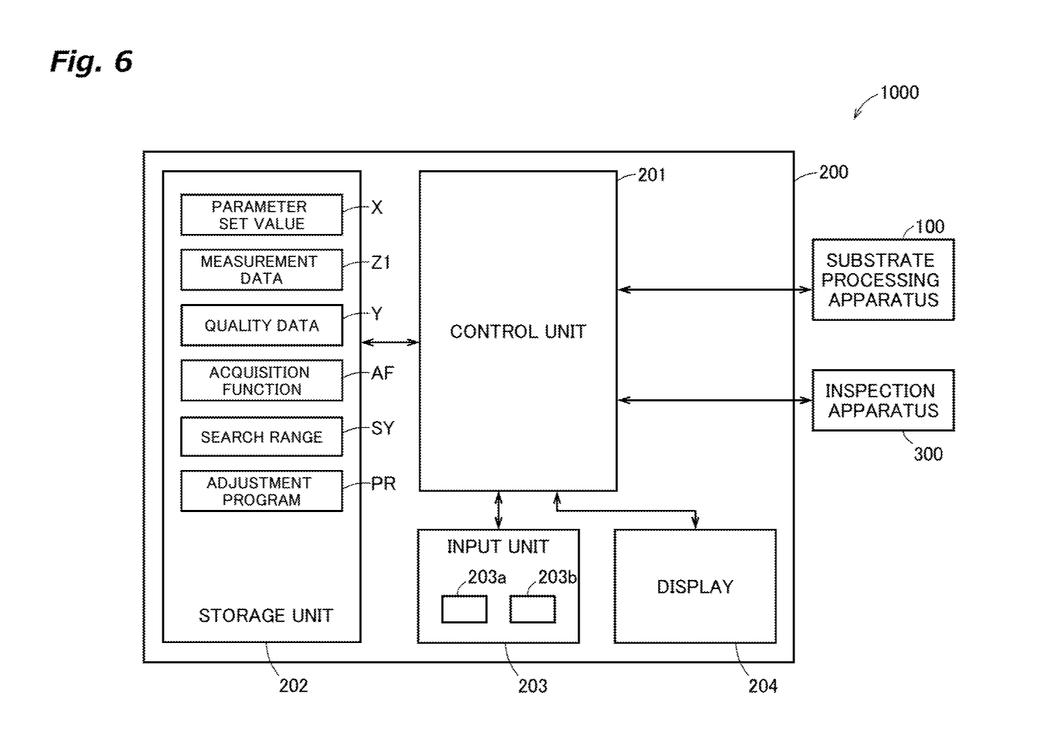

FIG. 6 is a block diagram illustrating a configuration of the control apparatus 200 according to the present preferred embodiment. The control apparatus 200 is an example of a “control parameter adjustment apparatus”. The control apparatus 200 includes an input unit 203 and a display 204 in addition to the control unit 201 and the storage unit 202.

The input unit 203 is a user interface apparatus operated by an operator. The input unit 203 inputs an instruction (input signal) corresponding to the operation of the operator to the control unit 201. In addition, the input unit 203 inputs data corresponding to the operation of the operator to the control unit 201. The input unit 203 includes a keyboard 203a and a mouse 203b. The input unit 203 may include a touch sensor superimposed on a display surface of the display 204. A graphical user interface may be configured by superimposing the touch sensor on the display surface of the display 204. For example, the operator can operate the input unit 203 to start the processing of the substrate W by the substrate processing apparatus 100.

Note that the input unit 203 may further include an interface that can access a removable medium. The interface includes a slot into which a memory card is inserted, a USB terminal, and a reading apparatus that reads data from an optical disk. A USB cable of the memory card reader may be connected to the USB terminal.

The display 204 displays various screens or images. The display 204 includes, for example, a liquid crystal display apparatus. The display 204 displays a screen for the operator to operate the control apparatus 200 or the substrate processing apparatus 100. In addition, the display 204 may display the recommended value RX of the control parameter.

The substrate processing apparatus 100 inputs the measurement data Z1 to the control apparatus 200. The inspection apparatus 300 inputs the quality data Y to the control apparatus 200. The control unit 201 stores the input measurement data Z1 and quality data Y in the auxiliary storage apparatus 202b.

The auxiliary storage apparatus 202b stores the set value X of the control parameter, the measurement data Z1, the quality data Y, the acquisition function AF, the search range SW, and the adjustment program PR. The control unit 201 generates the recommended value RX of the control parameter using the set value X of the control parameter, the measurement data Z1, the quality data Y, the acquisition function AF, the search range SW, and the adjustment program PR. Specifically, the control unit 201 executes the data set generation step S2 and the recommended value acquisition step S3 illustrated in FIG. 1.

The adjustment program PR includes a machine learning model. In addition, the adjustment program PR further includes a program for executing Bayesian optimization. The acquisition function AF and the search range SW are used for Bayesian optimization. Note that the adjustment program PR may include the acquisition function AF and the search range SW.

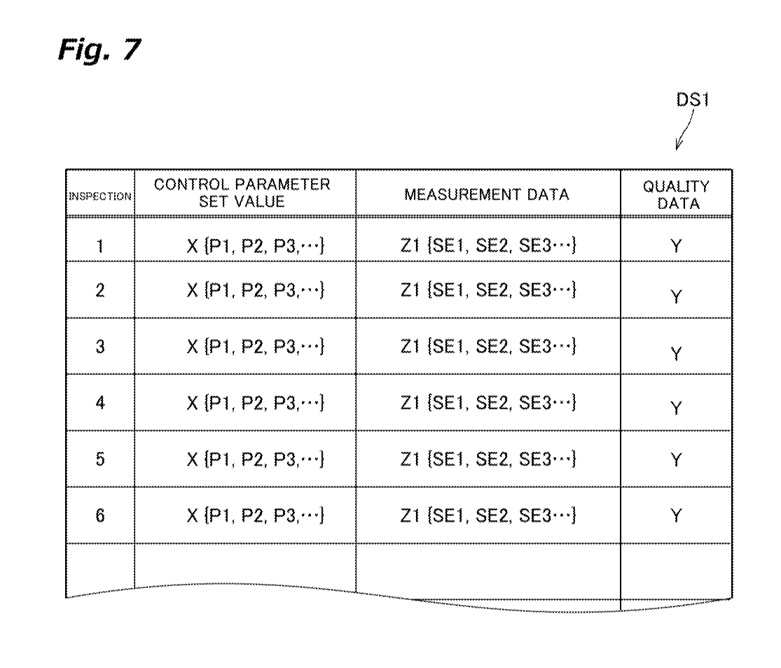

FIG. 7 is a diagram illustrating a data set DS1 including the set value X of the control parameter, the measurement data Z1, and the quality data Y. As illustrated in FIG. 7, the set value X of the control parameter indicates a set of set values P (set values P1, P2, and the like) of various control parameters. The measurement data Z1 indicates a set of detection results SE (SE1, SE2, and the like) of various sensors provided in the substrate processing apparatus 100. The auxiliary storage apparatus 202b stores the set value X of the control parameter, the measurement data Z1, and the quality data Y in association with each other for every quality inspection step S1 illustrated in FIG. 1.

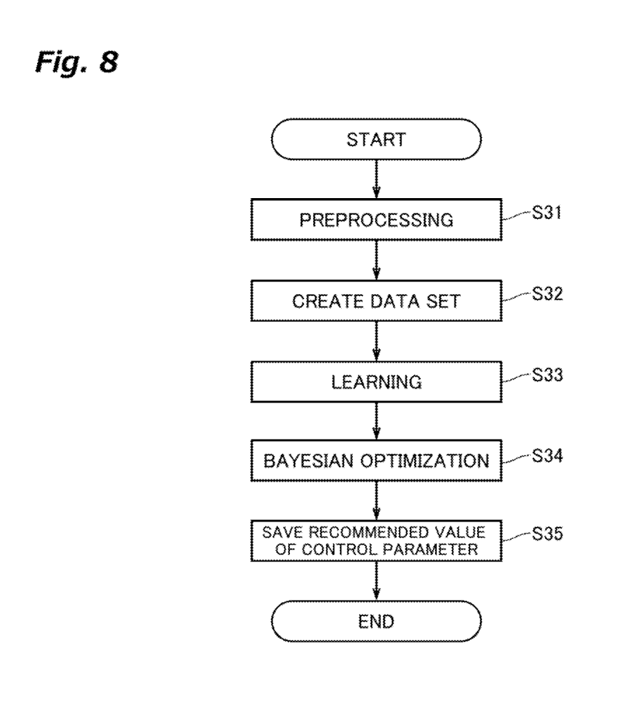

FIG. 8 is a flowchart illustrating the control parameter adjustment method according to the preferred embodiment. FIG. 8 illustrates a flow of processing executed by the control unit 201. The control parameter adjustment method illustrated in FIG. 8 includes the data set generation step S2 and the recommended value acquisition step S3 illustrated in FIG. 1. The data set generation step S2 includes a preprocessing step S31 and a post-preprocessing data set creation step S32. The recommended value acquisition step S3 includes a learning step S33, an optimization step S34, and a saving step S35. The processing illustrated in FIG. 8 is started when the operator operates the input unit 203 to instruct acquisition of the recommended value RX.

As illustrated in FIG. 8, when an instruction to acquire the recommended value RX of the control parameter is given, the control unit 201 executes the preprocessing step S31. Specifically, the control unit 201 performs preprocessing on each detection result SE included in the measurement data Z1 to generate post-preprocessing measurement data Z2. The number of data of each detection result SE is reduced by the preprocessing. Hereinafter, the preprocessed detection result SE may be referred to as “post-preprocessing data ASE”. The post-preprocessing measurement data Z2 includes post-preprocessing data ASE(ASE1, ASE2, ASE3, and the like). The post-preprocessing measurement data Z2 is an example of “measurement data regarding a physical quantity”.

The preprocessing is, for example, processing of extracting a feature amount of raw data (detection result SE). For example, the preprocessing includes processing of reducing dimensions of the raw data (dimension reduction processing), processing of computing summary statistics of the raw data, or processing of extracting one or more arbitrary data from the raw data.

The dimension reduction processing is, for example, linear dimension reduction processing or non-linear dimension reduction processing. The linear dimension reduction processing is, for example, principal component analysis, independent component analysis, or tensor decomposition. The non-linear dimension reduction processing is, for example, a uniform manifold approximation and projection (UMAP) or a self-encoder. For example, the low-dimensional feature amount of the detection result SE (raw data) is acquired by the principal component analysis. Therefore, in a case where the preprocessing is the principal component analysis, the post-preprocessing data ASE indicates the low-dimensional feature amount of the detection result SE (raw data).

The summary statistic indicates, for example, an average value, a median value, or a mode value. By computing the summary statistics of the detection result SE (raw data), the average value, the median value, or the mode value of the detection result SE is acquired. Therefore, in a case where the preprocessing is processing of computing the summary statistics, the post-preprocessing data ASE indicates the average value, the median value, or the mode value of the detection result SE.

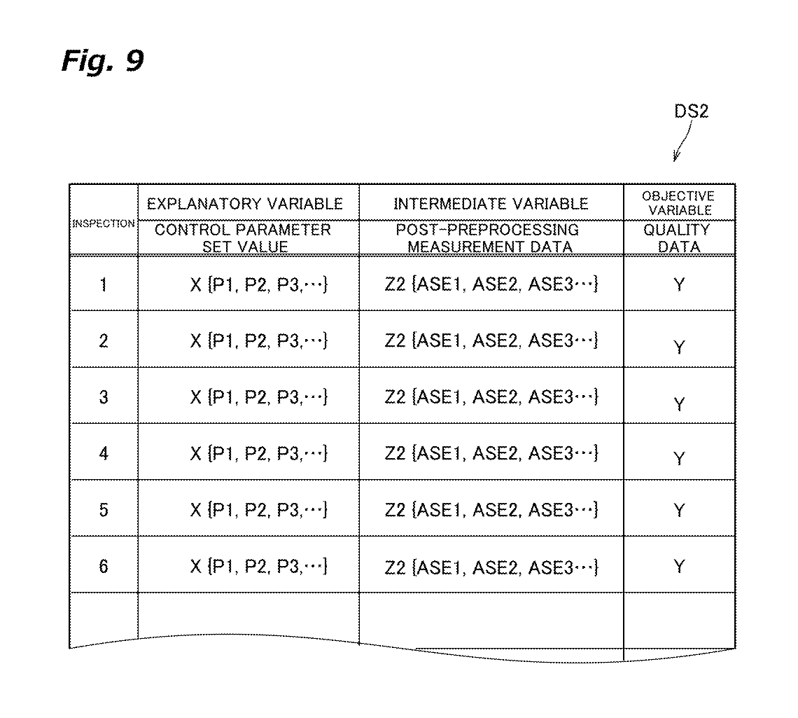

In the post-preprocessing data set creation step S32, the control unit 201 creates the post-preprocessing data set DS2 based on the set value X of the control parameter, the post-preprocessing measurement data Z2, and the quality data Y. The post-preprocessing data set DS2 is an example of training data and is used for machine learning. FIG. 9 is a diagram illustrating the post-preprocessing data set DS2 including the set value X of the control parameter, the post-preprocessing measurement data Z2, and the quality data Y. As illustrated in FIG. 9, in the post-preprocessing data set DS2, the set value X (P1, P2, P3, and the like) of the control parameter in each quality inspection, the post-preprocessing measurement data Z2 (ASE1, ASE2, ASE3, and the like), and the quality data Y are recorded in a state of being associated with each other.

In the learning step S33, the control unit 201 performs machine learning using the machine learning model and the post-preprocessing data set DS2. As a result, the control unit 201 acquires the prediction model PM for predicting the quality of the substrate processing. The prediction model PM is, for example, a model that predicts the number of particles attached to the substrate W by the substrate processing. The details on the learning step S33 will be described later.

In the optimization step S34, the control unit 201 executes Bayesian optimization based on the prediction model PM, the acquisition function AF, and the search range SW, and searches for the recommended value RX of the control parameter that brings the quality of the substrate processing close to the target quality. Specifically, the control unit 201 acquires the recommended value RX of the control parameter that maximizes the acquisition function AF within the search range SW by Bayesian optimization. Note that, depending on the index of the quality of the substrate processing, it may be assumed that the control unit 201 is designed to acquire the recommended value RX of the control parameter that minimizes the acquisition function. The optimization step S34 is an example of “search processing”.

The acquisition function AF is, for example, expected improvement (EI), mutual information (MI), probability of improvement (PI), or upper confidence bound (UCB). The search range SW is an arbitrary range. The search range SW is set based on, for example, a value input by the operator operating the input unit 203.

After the optimization step S34, the control unit 201 saves the recommended value RX obtained in the saving step S35 in the auxiliary storage apparatus 202b. Then, the control unit 201 ends the processing of the recommended value acquisition step S3.

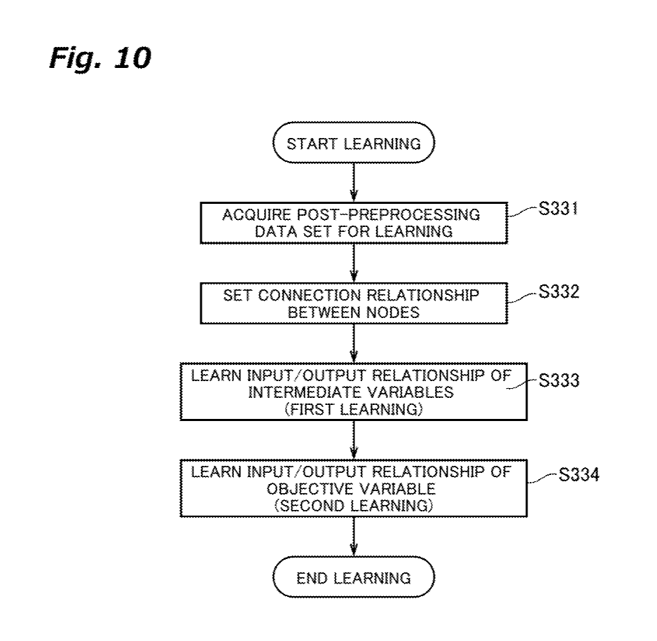

FIG. 10 is a detailed flowchart of the learning step S33 illustrated in FIG. 8. As described above, in the present preferred embodiment, in order to acquire the recommended value RX of the control parameter that brings the quality of the substrate processing close to the target quality by Bayesian optimization, a network N representing the data generation process of the quality data Y (objective variable) is constructed.

In the learning step S33, the control unit 201 acquires the post-preprocessing data set DS2 used for learning in data set acquisition processing S331. The control unit 201 acquires the post-preprocessing data set DS2 from the auxiliary storage apparatus 202b based on the operator's operation input of the input unit 203. Alternatively, the control unit 201 may automatically acquire the post-preprocessing data set DS2 from the post-preprocessing data set DS2 stored in the auxiliary storage apparatus 202b based on a predetermined rule. After the data set acquisition processing S331, the control unit 201 executes connection relationship setting processing S332.

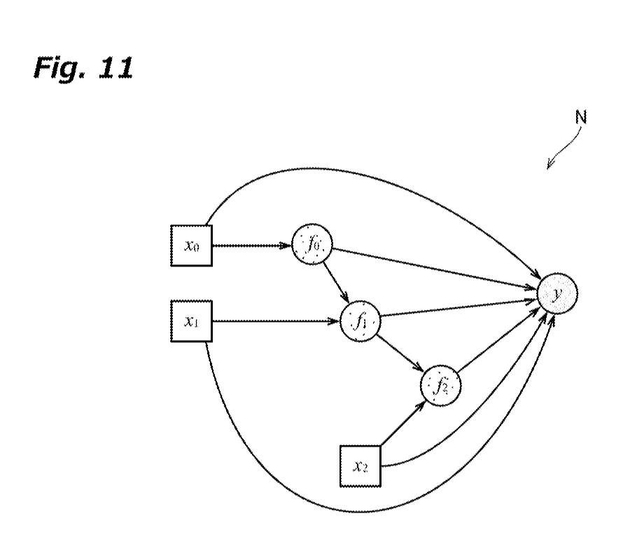

FIG. 11 is a diagram conceptually illustrating the network N. As illustrated in FIG. 11, in the network N, an explanatory variable x, an intermediate variable f, and an objective variable y are set as nodes, and the nodes are connected by an oriented edge indicating a causal relationship. The network N is a graph representing the data generation process of the objective variable y. Here, the explanatory variable x corresponds to the set value X of the control parameter, the intermediate variable f corresponds to the post-preprocessing measurement data Z2, and the objective variable y corresponds to the quality data Y. In order to implement Bayesian optimization, in the network N, the node of the intermediate variable f and the node of the objective variable y are designed to output a predicted distribution (average value (predicted value) and variance (index of uncertainty)) of each variable.

Returning to FIG. 10, the control unit 201 sets the connection relationship between the nodes in the connection relationship setting processing S332. Specifically, the control unit 201 receives designation related to a parent node of each of the intermediate variable f and the objective variable y from the operator via a graphical user interface (GUI) displayed on the display 204. Then, the parent node of each of the intermediate variable f and the objective variable y is set based on the designation. The GUI is an input interface displayed on the display 204 and allows the operator to visually select or designate the parent nodes of the intermediate variable f and the objective variable y. The control unit 201 constructs the network N as illustrated in FIG. 10 by setting the connection relationship between nodes. Note that it is possible to designate a certain intermediate variable as an input of another intermediate variable. However, it is not possible to designate such that circulation occurs between the variables.

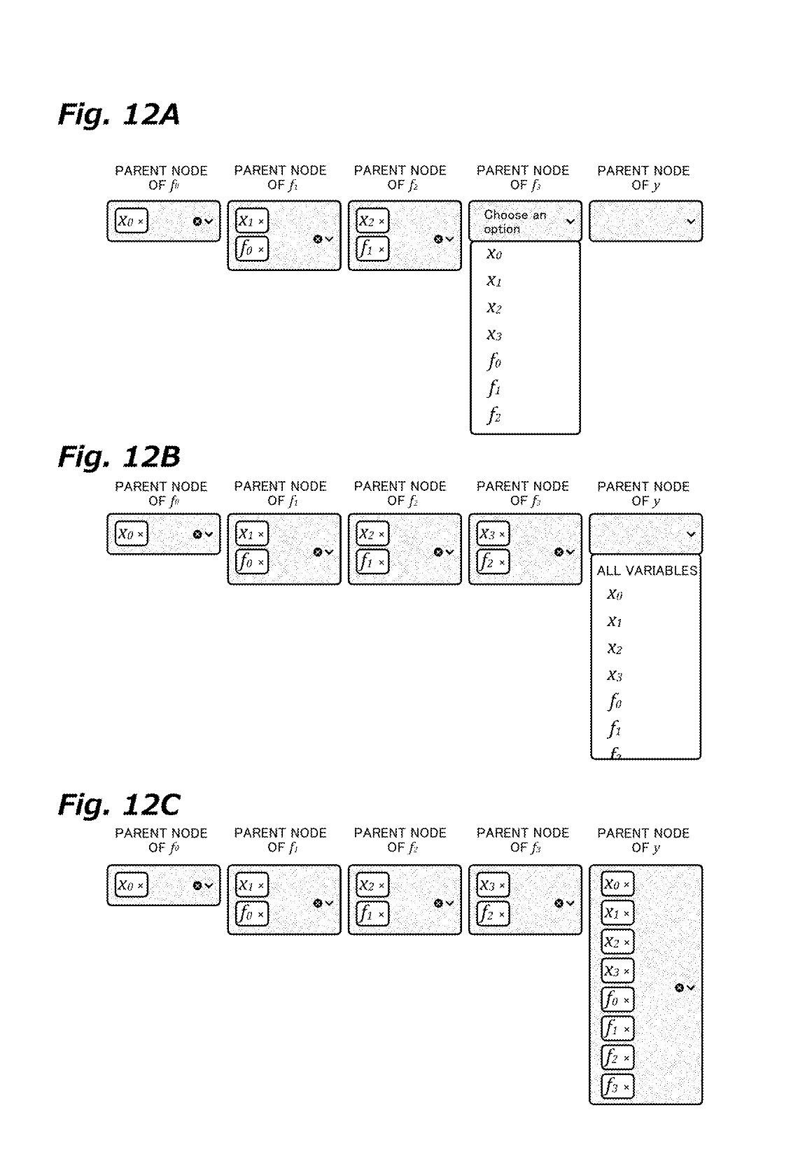

FIGS. 12A, 12B and 12C, are diagrams illustrating GUIs for designating the connection relationship of the network N. In this example, lists of the intermediate variable f (f₀ to f₃) and the objective variable y is disposed side by side on the display 204. A pull-down menu for selecting the parent node is disposed immediately below each variable.

The operator can check a list of selectable parent nodes by opening the pull-down menu. For example, when the operator opens the pull-down menu immediately below the intermediate variable f₃, an option list of selectable explanatory variables x (x₀ to x₃) and intermediate variables f (f₀ to f₂) is displayed, and it is possible to select an appropriate parent node from among the options one by one. When the parent node is selected, the control unit 201 may display the network structure (FIG. 11) on the display 204. Accordingly, the operator can visually confirm the network structure.

As illustrated in FIG. 12B, an option of “all variables” is provided in the pull-down menu of the objective variable y. By selecting the option, the operator can select all selectable explanatory variables x (x₀ to x₃) and intermediate variables f (f₀ to f₃) as the parent node of the objective variable y at once as illustrated in FIG. 12C.

Note that, in the connection relationship setting processing S332, the control unit 201 may automatically set all the selectable explanatory variables x and all the selectable intermediate variables f in the parent node of the objective variable y. In this case, the GUI (pull-down menu) for selecting the parent node of the objective variable y may be omitted.

The causal relationship between each explanatory variable x (set value X of the control parameter) and each intermediate variable f (post-preprocessing measurement data Z2) is often relatively clear. For example, it is clear that there is a causal relationship between the flow rate set value of a certain processing solution and the flow rate. Therefore, the connection relationship between the explanatory variable x and the intermediate variable f can be designated with high accuracy. On the other hand, a causal relationship between the explanatory variable x and the objective variable y (quality data Y) or a causal relationship between the intermediate variable f and the objective variable y is not clear in many cases. For example, it is difficult to appropriately determine whether or not the information of the explanatory variable x is aggregated into the intermediate variable f or the explanatory variable x is to be connected to the objective variable y since it is affecting the objective variable y. In such a case, it is conceivable to connect all selectable explanatory variables x and intermediate variables f with the objective variable y.

Note that, in the present preferred embodiment, the parent node can be designated for both the plurality of explanatory variables x and the plurality of intermediate variables f. However, only one of the plurality of explanatory variables x and the plurality of intermediate variables f may be designated as the parent node.

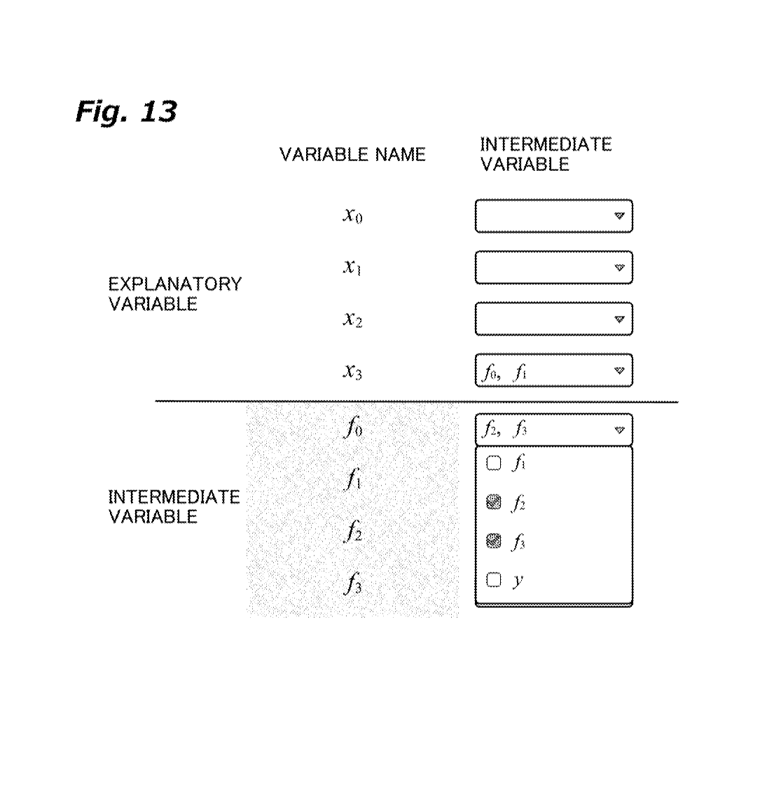

FIG. 13 is a diagram illustrating a modification of a GUI for designating a connection relationship of the network N. The GUI illustrated in FIG. 13 accepts designation of child nodes of the explanatory variable x and the objective variable y. Specifically, a list (x₀ to x₃) of the explanatory variables x and a list of the intermediate variables f (f₀ to f₃) are disposed vertically. Next to each variable, a pull-down menu for selecting a child node is disposed. The operator can check a list of variables selectable as child nodes by opening the pull-down menu. In addition, as illustrated in FIG. 13, in the pull-down menu, a check box is disposed next to each variable. When the operator selects the check box, the control unit 201 sets the corresponding variable as the child node.

Note that the GUI for designating the connection relationship of each node is not limited to the GUIs illustrated in FIGS. 12A to 12C and 13. For example, a connection relationship may be designated by constructing a graph of a network structure as illustrated in FIG. 10. Specifically, the control unit 201 displays boxes representing nodes and icons for selecting edges (arrows) for connecting the nodes on the display 204. Each node is given a variable name label. In addition, in order to identify the explanatory variable x, the intermediate variable f, and the objective variable y, each node may be displayed in a different shape or a different color.

The operator disposes each node by dragging and dropping, and draws an arrow for designating a parent node (or child node) by selecting an edge icon. Note that, in a case where an erroneous connection is made, an error message or a warning icon may be displayed. Accordingly, the operator can construct an appropriate network N.

Returning to FIG. 10, the control unit 201 executes first learning processing S333 after the connection relationship setting processing S332. The first learning processing S333 learns an input/output relationship of each intermediate variable f in the network N using the post-preprocessing data set DS2. That is, in the first learning processing S333, the control unit 201 learns the relationship between the explanatory variable x connected to each intermediate variable f and the other intermediate variable f for each intermediate variable f using the set value X of the control parameter of the post-preprocessing data set DS2, the post-preprocessing measurement data Z2, and the machine learning model. As the machine learning model of the first learning processing S333, a model capable of generating a predicted distribution (average value and variance) of the intermediate variable f is used. Specifically, Gaussian process regression, Bayesian linear regression, hierarchical Bayesian model, Bayesian deep learning, or natural gradient boosting (NGBoost) can be used. The control unit 201 acquires the learned machine learning models as many as the number of intermediate variables f by the first learning processing S333.

After the first learning processing S333, the control unit 201 executes second learning processing S334. In the second learning processing S334, the control unit 201 learns the input/output relationship of the objective variable y in the network N using the post-preprocessing data set DS2. That is, in the second learning processing S334, the control unit 201 learns the relationship between the explanatory variable x and the intermediate variable f connected to the objective variable y and the objective variable y using the post-preprocessing data set DS2 and the machine learning model. As the machine learning model of the second learning processing S334, a model capable of generating a predicted distribution (average value and variance) of the objective variable y is used. Specifically, Gaussian process regression, Bayesian linear regression, hierarchical Bayesian model, Bayesian deep learning, or natural gradient boosting (NGBoost) can be used.

In addition, in the second learning processing S334, the control unit 201 applies a prior distribution that induces sparsity as a prior distribution of weight parameters of the explanatory variable x and the intermediate variable f. Inducing sparsity refers to bringing an unnecessary input among inputs to the objective variable y close to zero.

Specifically, a prior distribution that induces sparsity is used based on a high-dimensional Bayesian optimization method (“High-dimensional Bayesian optimization with sparse axis-aligned subspaces”, Proceedings of Machine Learning Research (2021): 493-503) proposed by David Eriksson et al. In this method, a half-Cauchy distribution is adopted as a prior distribution of parameters for controlling the importance of each explanatory variable among hyperparameters in the kernel function of the Gaussian process. The half-Cauchy distribution is a heavy-tailed distribution limited to the positive range. Due to this characteristic, the weight for the input with low importance (explanatory variable x or intermediate variable f) or the weight for the intermediate variable f tends to gather near zero, while a large weight is assigned to the important input with sufficient information. Accordingly, it is possible to perform learning in which an essential structure of data is captured while automatically suppressing unnecessary dimensions.

By applying the prior distribution that induces sparsity, it is possible to automatically identify and learn an important explanatory variable x and an important intermediate variable f from among inputs even in a case where the data generation process of the objective variable y is not clear or in a case where the inputs to the objective variable y are increased in dimension. In particular, in the application range of the present preferred embodiment, it is possible to obtain highly accurate prediction and optimal solution with a smaller number of trials as compared with the conventional Bayesian optimization method while reducing the calculation cost of optimization.

Note that, in the present preferred embodiment, the half-Cauchy distribution is used as the prior distribution for inducing sparsity, but the present invention is not limited thereto, and other appropriate prior distributions including the Laplace distribution and the sparse Gaussian process can be applied.

Furthermore, No-U-Turn Sampling (NUTS) can be used as an inference method in the second learning processing S334. The NUTS is a kind of adaptive method of the Hamiltonian Monte Carlo method, and is a standard method of inference for a complex model. In addition, maximum a posteriori (MAP) estimation can be adopted instead of the NUTS.

The control unit 201 constructs the prediction model PM by combining some learned machine learning models obtained in the first learning processing S333 and the second learning processing S334. Then, in the Bayesian optimization step S34 (search processing) illustrated in FIG. 8, the control unit 201 executes Bayesian optimization using the constructed prediction model PM.

As described above, according to the control parameter adjustment method and the control parameter adjustment apparatus of the present preferred embodiment, even in a case where the causal relationship between the control parameter that is the explanatory variable or the measurement data that is the intermediate variable and the objective variable that is the quality of the substrate processing is not clear, it is possible to appropriately learn the important input of the objective variable by using the prior distribution that induces sparsity as the prior distribution of the weight parameter. Therefore, in the network N, even if the explanatory variable x and the intermediate variable f with low importance are connected to the objective variable, it is possible to avoid a decrease in the prediction accuracy of the network N. In addition, since a decrease in the optimization accuracy of the control parameter can be avoided, the quality of the substrate processing can be improved.

In particular, in the network N, in a case where a large number of explanatory variables x or intermediate variables f are connected to the objective variable y, the input of the objective variable y is increased in dimension, leading to a decrease in prediction accuracy of the model after learning and a decrease in sampling efficiency in Bayesian optimization. Therefore, in the present preferred embodiment, by using the prior distribution that induces sparsity, even in a case where the input of the objective variable y is high-dimensional, it is possible to learn a particularly important input from the input. Therefore, in the connection relationship setting processing S332, even in a case where the explanatory variable x or the intermediate variable f is arbitrarily designated as the parent node of the objective variable y, or even in a case where all the explanatory variables x or intermediate variables f are set, it is possible to avoid a decrease in the prediction accuracy of the network N after learning. In addition, it is possible to avoid a decrease in optimization accuracy due to Bayesian optimization. Therefore, the quality of substrate processing can be improved.

### 2. Modifications

Although the preferred embodiment has been described above, the present invention is not limited to the above, and various modifications can be made.

For example, in the above preferred embodiment, since the machine learning is performed using the preprocessed post-preprocessing data set DS2, over-learning hardly occurs. Therefore, the prediction accuracy of the machine learning model is improved, and the quality of the substrate processing can be improved. However, machine learning may be performed using the data set DS1 of raw data that is not preprocessed.

In the above preferred embodiment, the substrate processing apparatus 100 performs the etching processing or the cleaning processing, but the substrate processing is not limited to the etching processing and the cleaning processing. For example, the substrate processing may be brush cleaning processing, photosensitive film coating processing, development processing, annealing processing, or pattern writing processing.

Although the present invention has been described in detail, the above description is illustrative in all aspects, and the present invention is not limited thereto. It is understood that numerous modifications not indicated can be assumed without departing from the scope of the present invention. The configurations described in the above preferred embodiment and modifications can be appropriately combined or omitted as long as they do not contradict each other.

### 3. Summary of Preferred Embodiment

A first aspect is a control parameter adjustment apparatus that adjusts a set value of a control parameter of a substrate processing apparatus that operates based on the control parameter to process a substrate, including an arithmetic processing unit that calculates a recommended value of the control parameter, wherein the arithmetic processing unit can execute: connection relationship setting processing of setting a connection relationship between nodes by using the control parameter as an explanatory variable, using measurement data related to a physical quantity measured by the substrate processing apparatus as an intermediate variable, using quality data related to a quality of substrate processing by the substrate processing apparatus as an objective variable, and using the explanatory variable, the intermediate variable, and the objective variable as nodes; first learning processing of learning an input/output relationship of the intermediate variable in a network based on the connection relationship set by the connection relationship setting processing using a data set of the explanatory variable and the intermediate variable; second learning processing of learning an input/output relationship of the objective variable in the network using a data set of the explanatory variable, the intermediate variable, and the objective variable; and search processing of executing Bayesian optimization using a prediction model obtained by the first learning processing and the second learning processing, a search range, and an acquisition function, and searching for a recommended value of the control parameter that brings the quality close to a target quality, and the arithmetic processing unit uses a prior distribution that induces sparsity as a prior distribution of weight parameters in the second learning processing.

A second aspect is the control parameter adjustment apparatus according to the first aspect, wherein, in the connection relationship setting processing, the arithmetic processing unit sets all the selectable explanatory variables, all the selectable intermediate variables, or both of them to a parent node of the objective variable.

A third aspect is the control parameter adjustment apparatus according to the first aspect, wherein the arithmetic processing unit uses a half-Cauchy distribution as the prior distribution in the second learning processing.

A fourth aspect is the control parameter adjustment apparatus according to the first aspect, further including: an input unit that receives an input; and a display, wherein in the connection relationship setting processing, the arithmetic processing unit performs processing of displaying, on the display, a GUI for receiving an input designating a connection relationship between a node of the explanatory variable and a node of the intermediate variable, an input designating a connection relationship between nodes of the intermediate variable, or both, and setting a connection of each node based on the input received via the input unit.

A fifth aspect is the control parameter adjustment apparatus according to the fourth aspect, wherein, in the connection relationship setting processing, the arithmetic processing unit performs processing of displaying, on the display, a GUI for receiving an input designating a connection relationship between a node of the explanatory variable and a node of the objective variable, an input designating a connection relationship between a node of the intermediate variable and a node of the objective variable, or both inputs, and setting a connection of each node based on the input received via the input unit.

A sixth aspect is the control parameter adjustment apparatus according to the fifth aspect, wherein the arithmetic processing unit displays, as a parent node of the objective variable, a GUI on the display, the GUI including an option for selecting variables one by one from the selectable explanatory variables or the selectable intermediate variables, and an option for selecting all the selectable explanatory variables or all the selectable intermediate variables at once.

A seventh aspect is a control parameter adjustment method for adjusting a set value of a control parameter of a substrate processing apparatus that operates based on the control parameter to process a substrate, including: connection relationship setting processing of setting a connection relationship between nodes by using the control parameter as an explanatory variable, using measurement data related to a physical quantity measured by the substrate processing apparatus as an intermediate variable, using quality data related to a quality of substrate processing by the substrate processing apparatus as an objective variable, and using the explanatory variable, the intermediate variable, and the objective variable as nodes; first learning processing of learning an input/output relationship of the intermediate variable in a network based on the connection relationship set by the connection relationship setting processing using a data set of the explanatory variable and the intermediate variable; second learning processing of learning an input/output relationship of the objective variable in the network using a data set of the explanatory variable, the intermediate variable, and the objective variable; and search processing of executing Bayesian optimization using a prediction model obtained by the first learning processing and the second learning processing, a search range, and an acquisition function, and searching for a recommended value of the control parameter that brings the quality close to a target quality.

An eighth aspect is a computer program executable by a computer, the computer program causing the computer to execute each piece of processing of the control parameter adjustment method according to the seventh aspect.

According to the first to eighth aspects, by using the prior distribution that induces sparsity, the value of an important input for the objective variable is maintained at a large value and an unimportant input is reduced. With this characteristic, the important input of the objective variable can be appropriately learned. Therefore, even in a case where the explanatory variable and the intermediate variable having low importance are connected to the objective variable in the network, it is possible to avoid a decrease in prediction accuracy of the network. Accordingly, it is possible to avoid a decrease in the optimization accuracy of the control parameter, and thus, it is possible to improve the quality of the substrate processing.

According to the control parameter adjustment apparatus of the third aspect, since the half-Cauchy distribution is a heavy-tailed distribution limited to the positive range, the weight for a variable with low importance tends to gather near zero, and the weight for an important variable is large. Therefore, the fitting efficiency can be enhanced.

According to the control parameter adjustment apparatus of the fourth aspect, the parent node of the intermediate variable can be set based on the input designated by the operator via the GUI.

According to the control parameter adjustment apparatus of the fifth aspect, the parent node of the objective variable can be set based on the input designated by the operator.

According to the control parameter adjustment apparatus of the sixth aspect, the operator can designate the explanatory variables or the intermediate variables one by one, or can designate all the explanatory variables or intermediate variables at once.

While the invention has been shown and described in detail, the foregoing description is in all aspects illustrative and not restrictive. It is therefore understood that numerous modifications and variations can be devised without departing from the scope of the invention.

What is claimed is:

1. A control parameter adjustment apparatus that adjusts a set value of a control parameter of a substrate processing apparatus operating based on the control parameter to process a substrate comprising:
an arithmetic processing unit that calculates a recommended value of the control parameter,
wherein the arithmetic processing unit executes:
connection relationship setting processing of setting a connection relationship between nodes by using the control parameter as an explanatory variable, using measurement data related to a physical quantity measured by the substrate processing apparatus as an intermediate variable, using quality data related to a quality of substrate processing by the substrate processing apparatus as an objective variable, and using the explanatory variable, the intermediate variable, and the objective variable as nodes;
first learning processing of learning an input/output relationship of the intermediate variable in a network based on the connection relationship set by the connection relationship setting processing using a data set of the explanatory variable and the intermediate variable;
second learning processing of learning an input/output relationship of the objective variable in the network using a data set of the explanatory variable, the intermediate variable, and the objective variable; and
search processing of executing Bayesian optimization using a prediction model obtained by the first learning processing and the second learning processing, a search range, and an acquisition function, and searching for a recommended value of the control parameter that brings the quality close to a target quality, and
the arithmetic processing unit uses a prior distribution that induces sparsity as a prior distribution of weight parameters in the second learning processing.

2. The control parameter adjustment apparatus according to claim 1, wherein in the connection relationship setting processing, the arithmetic processing unit sets all the selectable explanatory variables, all the selectable intermediate variables, or both of them as parent nodes of the objective variable.

3. The control parameter adjustment apparatus according to claim 1, wherein the arithmetic processing unit uses a half-Cauchy distribution as the prior distribution in the second learning processing.

4. The control parameter adjustment apparatus according to claim 1, further comprising:
an input unit that receives an input; and
a display,
wherein in the connection relationship setting processing, the arithmetic processing unit performs processing of displaying, on the display, a GUI for receiving an input designating a connection relationship between a node of the explanatory variable and a node of the intermediate variable, an input designating a connection relationship between nodes of the intermediate variable, or both, and setting a connection of each node based on the input received via the input unit.

5. The control parameter adjustment apparatus according to claim 4, wherein in the connection relationship setting processing, the arithmetic processing unit performs processing of displaying, on the display, a GUI for receiving an input designating a connection relationship between a node of the explanatory variable and a node of the objective variable, an input designating a connection relationship between a node of the intermediate variable and a node of the objective variable, or both inputs, and setting a connection of each node based on the input received via the input unit.

6. The control parameter adjustment apparatus according to claim 5, wherein the arithmetic processing unit displays, as a parent node of the objective variable, a GUI on the display, the GUI including an option for selecting variables one by one from the selectable explanatory variables or the selectable intermediate variables, and an option for selecting all the selectable explanatory variables or all the selectable intermediate variables at once.

7. A control parameter adjustment method for adjusting a set value of a control parameter of a substrate processing apparatus that operates based on the control parameter to process a substrate, the control parameter adjustment method comprising:
connection relationship setting processing of setting a connection relationship between nodes by using the control parameter as an explanatory variable, using measurement data related to a physical quantity measured by the substrate processing apparatus as an intermediate variable, using quality data related to a quality of substrate processing by the substrate processing apparatus as an objective variable, and using the explanatory variable, the intermediate variable, and the objective variable as nodes;
first learning processing of learning an input/output relationship of the intermediate variable in a network based on the connection relationship set by the connection relationship setting processing using a data set of the explanatory variable and the intermediate variable;
second learning processing of learning an input/output relationship of the objective variable in the network using a data set of the explanatory variable, the intermediate variable, and the objective variable; and
search processing of executing Bayesian optimization using a prediction model obtained by the first learning processing and the second learning processing, a search range, and an acquisition function, and searching for a recommended value of the control parameter that brings the quality close to a target quality.

8. A storage medium stroing a computer program executable by a computer, wherein the computer program causes the computer to execute each piece of processing of the control parameter adjustment method according to claim 7.
